(19) United States
(12) Patent Application Publication
(10) Pub. No.: US 2014/0358901 A1
(43) Pub. Date: Dec. 4, 2014

(54) DISPLAY APPARATUS AND SEARCH RESULT DISPLAYING METHOD THEREOF

(71) Applicant: SAMSUNG ELECTRONICS CO., LTD., Suwon-si (KR)

(72) Inventor: Seong-yul KIM, Yeosu-si (KR)

(21) Appl. No.: 14/282,777

(22) Filed: May 20, 2014

(30) Foreign Application Priority Data
May 31, 2013 (KR) 10-2013-0062241

(51) Int. Cl. G06F 17/30; H04N 21/462; H04N 21/8405; H04N 21/2665; H04N 21/482; H04N 21/278

(52) U.S. Cl. CPC G06F 17/30386; H04N 21/4828; H04N 21/278; H04N 21/8405; H04N 21/2665; H04N 21/4622
USPC 707/722

(57) ABSTRACT

A display apparatus including an input unit configured to receive a keyword, a display configured to display a screen based on search result received from a plurality of sources, and a controller configured to control the plurality of sources to perform search based on the keyword, receive a plurality of search result screens corresponding to the search result searched from the plurality of sources, and display the screen on the display.

### CROSS-REFERENCE TO RELATED APPLICATIONS

This application claims priority benefit from Korean Patent Application No. 10-2013-0062241, filed on May 31, 2013, in the Korean Intellectual Property Office, the disclosure of which is incorporated herein by reference in its entirety.

### BACKGROUND

1. Field

Example embodiments of the following disclosure relate to a display apparatus and a search result displaying method thereof, and more particularly, to a display apparatus which searches a content from a plurality of sources and displays the content on a multi-view screen by the plurality of sources and a method thereof.

2. Description of the Related Art

In general, integrated search refers to a search method which categorizes by sections and displays all the data, such as, café, blog, dictionary, image, video, music, latest news, region, book, shopping, my PC, etc., related to an input keyword. A collection ranking in which an order of exposure of the collection automatically differs by calculating which information is most searched by keywords, and a multi-ranking that decides which content is located on the top within each section are applied.

These days, it is available to collect a content and content information which exist in a content sharing solution (e.g., eMule, Ares Galaxy, etc.) or web service (e.g., YouTube, Pandora TV, etc.), generate summary information, and display such information on a multimedia user interface.

In particular, a smart TV generally refers to a TV through which a user can view video by freely accessing TV, a mobile phone, and a PC without buffering of data. A smart TV may also be referred to as an ‘Internet TV’ or a ‘connected TV.’ By using a smart TV, a user can download a content from the Internet on a real-time basis and check news, weather information, and e-mail immediately.

When inputting a keyword desired by a user to the smart TV, the smart TV displays a keyword result as letters, and a user selects the search result and moves to content to which the user wants to move.

However, when performing search by using the former search method, if the search does not yield results desired by the user, the user should perform the search and the same procedures again, and thus, it is required to come up with a measure to perform the search from various content sources, categorize the sources, and display the search result on a screen.

### SUMMARY

Additional aspects and/or advantages will be set forth in part in the description which follows and, in part, will be apparent from the description, or may be learned by practice of the invention.

An aspect of the exemplary embodiments provides a display apparatus and a search result displaying method, so that users may perform search from a plurality of sources, categorize a search result by a plurality of sources, and display the result on a multi-split screen.

A display apparatus according to an exemplary embodiment includes an input unit configured to receive a keyword; a display configured to display a screen based on search result received from a plurality of sources; and a controller configured to control the plurality of sources to perform search based on the keyword, receive a plurality of search result screens corresponding to a search result searched from the plurality of sources, and display the screen including the search result screens on the display.

Herein, the controller, when the keyword is input, may select the plurality of sources by using source information set as a default.

The controller, when the keyword is input while a plurality of source screens are displayed on the display, may control a source corresponding to the plurality of source to search a content corresponding to the keyword.

The controller may generate the plurality of search result screens as a screen having a first transparency and display the screen to be overlapped with an original screen displayed on the display.

The controller, when a content is selected on a first search result screen which is one of the plurality of search result screens, may generate a selected content screen as a screen having a second transparency and display the screen to be overlapped with the first search result screen.

The controller, when the content is re-selected on the first search result screen, or the content screen is selected, may delete the original screen and the plurality of search result screens, and display the content screen in a full screen size.

The controller, when a content is selected on a first search result screen which is one of the plurality of search result screens, may block output of an audio signal corresponding to the original screen and output an audio signal corresponding to the selected content.

The controller may list and display a search result on the plurality of search result screens.

The plurality of sources may include at least one of a broadcasting channel, a content display apparatus connected to an external input port, a storage media stored inside or outside the display apparatus, and a web server.

An aspect of the exemplary embodiments provides a method of displaying a search result of a display apparatus according to the exemplary embodiments including receiving a keyword to search a content; controlling the plurality of sources to perform search based on the keyword; and receiving a plurality of search result screens corresponding to a search result searched from the plurality of sources and displaying a screen including the search result screens.

The method further includes, when the keyword is input, selecting the plurality of sources by using source information set as a default.

The method further includes, when the keyword is input while a plurality of source screens are displayed, searching a content corresponding to the keyword from a source corresponding to the plurality of source screens.

The method further includes generating the plurality of search result screens as a screen having a first transparency and displaying the screen to be overlapped with an original screen displayed.

The method further includes, when a content is selected on a first search result screen which is one of the plurality of search result screens, generating a selected content screen as a screen having a second transparency, and displaying the screen to be overlapped with the first search result screen.

The method further includes, when the content is re-selected on the first search result screen or the content screen is selected, deleting the original screen and the plurality of search result screens, and displaying the content screen in a full screen size.

The method of claim further includes, when a content is selected on a first search result screen which is one of the plurality of search result screens, blocking output of an audio signal corresponding to the original screen, and outputting an audio signal corresponding to the selected content.

The method, wherein the displaying may include listing up and displaying a search result on the plurality of search result screens.

The method, wherein the plurality of sources may include at least one of a broadcasting channel, a content display apparatus connected to an external input port, a media stored inside or outside the display apparatus, and a web server.

An aspect of the exemplary embodiments provides an apparatus including: an input unit configured to receive a keyword; a display; and a controller configured to perform a search through a plurality of sources using the received keyword, and to display search result screens corresponding to the plurality of sources such that the search result screens overlap an original screen on the display.

The apparatus may further include: a photographing unit configured to recognize a user, wherein search result history of the recognized user during a predetermined period is displayed.

As described above, according to various exemplary embodiments, a function to perform search from a plurality of sources, categorize search results by a plurality of sources, and display the result on a multi-split screen may be provided. Accordingly, a user may obtain a search result rapidly, avoiding a repetitive procedure to perform search again when search result is not what the user wants.

### BRIEF DESCRIPTION OF THE DRAWINGS

These and/or other aspects and advantages will become apparent and more readily appreciated from the following description of the embodiments taken in conjunction with the accompanying drawings in which:

FIG. 1 illustrates a block diagram which shows the configuration of a display apparatus, according to an exemplary embodiment,

FIG. 2 illustrates a block diagram to explain a detailed configuration of a display apparatus, according to an exemplary embodiment,

FIGS. 3-7 are views illustrating drawings to perform a search based to an input keyword and display a plurality of search result screens, according to an exemplary embodiment,

FIG. 8 is a view illustrating a drawing to display an original screen and a search screen on a split screen, according to an exemplary embodiment,

FIGS. 9A and 9B are views illustrating drawings to explain a search user interface (UI) according to user history, according to an exemplary embodiment,

FIG. 10 is a flow chart illustrating a method of displaying a search result of a display apparatus, according to an exemplary embodiment,

FIG. 11 is a flow chart illustrating a method of displaying a plurality of search result screens of a display apparatus, according to an exemplary embodiment.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

Certain exemplary embodiments are described in higher detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

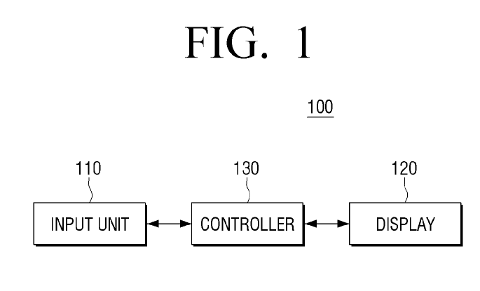

FIG. 1 is a block diagram that illustrates the configuration of the display apparatus, according to an exemplary embodiment. According to FIG. 1, a display apparatus may 100 include an input unit 110, a display 120, and a controller 130. The display apparatus 100 may be embodied as a various types of an electronic device, such as a TV, a Smartphone, a tablet, a desktop PC, a notebook, etc. Further, the above-described units may include at least one processing device.

The input unit 110 may receive a user command to receive various keywords. The controller 130 may perform search based on a keyword input to the input unit 110.

For example, when a keyword is input through the input unit 110, the controller 130 may perform a search based on the keyword through a plurality of sources, generate a plurality of search result screens searched from a plurality of sources, and display the results on a display.

In addition, the input unit 110 may receive a user command to perform channel alteration and volume control, etc., and the controller 130 may alter channel or control volume according to an input user command.

To do this, the input unit 110 may be embodied as an input panel. The input panel may be composed of a touch screen type or a key pad type having a touch pad, function keys, a number key, a special key, a letter key, however, the present disclosure is not limited thereto.

The display 120 displays a content screen or a plurality of search result screens. Specifically, the display 120, while displaying the former content screen on a full screen, when a keyword is input through the input unit 110, may display a plurality of search result screens according to a search result searched from a plurality of sources.

In this case, a plurality of search result screens are embodied as a split screen, wherein a search result searched from a plurality of sources may be displayed on a split screen by the plurality of sources. For example, a search result searched from a TV signal, a search result searched from the Internet, a search result searched from an external apparatus, a search result searched from an integrated content media, etc., are displayed on each split screen.

To do this, the display 120 may be embodied as Liquid Crystal Display (LCD), Organic Light Emitting Display (OLED), or Plasma Display Panel (PDP), etc.

The controller 130 may control overall operations of the display apparatus 100. The controller 130 may include RAM (Random Access Memory) for operations of a COU (central processing unit) and the display apparatus 100.

Particularly, the controller 130 may control the display 120 to display a plurality of search results on each split screen by sources. In this case, the controller 130 may control the display 120 to perform search based on the input keyword from a plurality of sources, generate and display a plurality of search result screens according to a search result searched from a plurality of sources.

Specifically, the controller 130, when a keyword is input, may select a plurality of sources by using source information set as a default. For example, among source information, such as a broadcasting channel, a web server, USB, a DVD player, a media stored inside or outside the display apparatus, or other external apparatus, a user may select one or more sources which the user intends to search. However, this is a mere example, and search may be performed from all the sources that may be communicated.

When a plurality of sources are selected, search may be performed based on the keyword from a plurality of sources, and a plurality of search result screens may be generated according to search results searched from the plurality of sources.

The controller 130 splits a screen and displays a plurality of search result screens on each split screen. For example, a screen may be split according to the number of a plurality of sources.

A split screen may be embodied by using a PIP (Picture In Picture). When using the PIP screen, it may be embodied that a size of the PIP screen is adjusted so that a screen may be seen as a split screen.

The controller 130 may generate a plurality of search result screens as a screen having a first transparency, and displays the screens to be overlapped with an original screen displayed on the display 120. In this case, the controller 130 adjusts transparency of a plurality of search result screens and displays the screens to be overlapped with an original screen displayed on the display 120. For example, a user may view a plurality of search result screens while viewing an original screen.

In addition, when a content is selected from a first search result screen among a plurality of search result screens, the controller 130 may generate the selected content screen as a screen having a second transparency while the selected content is highlighted, and display the screen to be overlapped with a first search result screen. In this case, the controller 130 displays the screen to be overlapped with the first search result screen by adjusting transparency of the selected content screen. Accordingly, a user, when selecting a content on the first search result screen, may directly view and check the content screen.

Meanwhile, the controller 130 may control the display 120 so that a first search result screen may be displayed to be overlapped with the content screen by adjusting transparency of the first search result screen and the content screen, but not to display the first search result or the original screen overlapped with the content screen.

In addition, when the highlighted content is re-selected on the first search result screen or when the content screen being displayed is selected, the controller 130 may delete an original screen and a plurality of search result screens, expand the content screen to the full screen size, and display the screen.

Additionally, when the content is selected on the first search result screen, the controller 130 may block output of an audio signal corresponding to the original screen and output an audio signal corresponding to the selected content. For example, when a user selects a content on the first search result screen, the controller 130 may display the first search result screen and the content screen to be overlapped, and output an audio signal corresponding to the selected content. Therefore, when a content is selected on the first search result screen, a user may listen to audio of the selected content while viewing the content screen.

The controller 130 may list and display a plurality of search result screens. For example, the controller 130 may list the search result searched from a broadcasting channel by broadcasting stations or list search results searched from a web server by sites or media types.

For example, a plurality of sources may include at least one of a broadcasting channel, a content display apparatus connected to an external input port, a media stored inside or outside the display apparatus, and a web server, or other apparatuses available to communicate. The above-described plurality of sources is exemplary, and thus, the present disclosure is not limited thereto.

As described above, according to an exemplary embodiment, the display apparatus 100 may perform search from a plurality of sources based on the input keyword, generate a plurality of search result screens by a plurality of sources, and display the screens. Accordingly, a user may input a keyword and view the searched results from the plurality of sources at a glance on one screen, avoiding the repetitive procedure to search a keyword again.

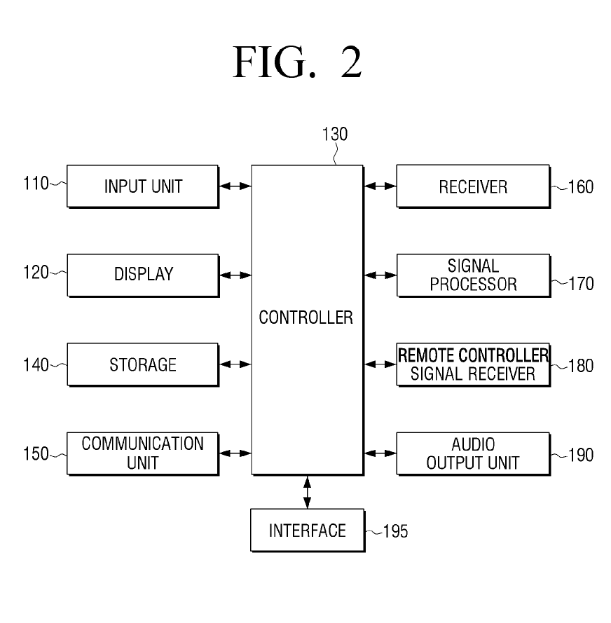

FIG. 2 illustrates a block diagram to explain the detailed configuration of the display apparatus, according to an exemplary embodiment. According to FIG. 2, the display apparatus 100 may further include, in addition to the components illustrated in FIG. 1, a storage 140, a communication unit 150, a signal processing unit 170, a remote controller receiver 180, a receiver 160, an audio output unit 190, and an interface 195. Operations of the above-described units may be controlled by the controller 130. Any one of the above-described units may include at least one processing device.

Meanwhile, the display apparatus 100 may be embodied as a TV, although the present disclosure is not limited thereto. As explanations on the input unit 110, the display 120, and the controller 130 are the same as the explanation in FIG. 1, detailed explanation will be omitted.

The storage 140 stores various data and Operating System (OS) to operate and control the display apparatus 100.

The storage 140 may store input keywords and search result a user selected.

Specifically, the storage 140 may store input keywords, and display user history of the keywords to the display 120 through the display so that a user may view keywords that the user searched during a predetermined period.

In addition, the storage 140 may store a download program executable at the display apparatus 100. For example, the download program may be an application program which is necessary for the display apparatus 100 to provide the additional functions or additional services in addition to the searching function of the display apparatus.

Specifically, the download program, unlike the basic program, may refer to an application program which may be installed at the display apparatus 100 or deleted arbitrarily by a user.

For example, a user may download the download program which may provide additional functions, such as a game or chatting function, from an external apparatus (not illustrated) and install the program at the display apparatus 100. The storage 140 may store the download program which may provide the corresponding additional function. The additional functions of the game or the chatting function are examples, and thus, the present disclosure is not limited thereto.

To do this, the storage 140 may be embodied as a storage media such as a non-volatile memory (for example, flash memory, EEROM (Electrically Erasable ROM) and hard disk, etc.

The communication unit 150 communicates with the network (not illustrated). Specifically, the communication unit 150 may communicate with various external apparatuses (for example, other apparatuses or servers) connected to the network, by using a network address allocated to the display apparatus 100 for network communication.

Meanwhile, the communication unit 150 may perform network communication by using various communication methods.

For example, the communication unit 150 may perform network communication by using various communication methods such as wire/wireless LAN (Local Area Network), Wi-Fi, WAN, Ethernet, Bluetooth, Zigbee, USB (Universal Serial Bus, IEEE 1394, etc.). The communication unit 150 may have various communication modules to perform network communication according to each communication method. For example, the communication unit 150, when communicating by wire LAN, may include a LAN card (not illustrated), and when communicating by Wi-Fi, the communication unit 150 may include a Wi-Fi communication chip (not illustrated).

The receiver 160 may receive a broadcasting content (or a broadcasting signal). The broadcasting content may include video, audio, and additional data (for example, EPG), and the receiver 160 may receive the broadcasting content from various sources, such as terrestrial TV broadcasting, cable broadcasting, satellite broadcasting, Internet broadcasting, and the like.

For example, the receiver 160, to receive the broadcasting content transmitted from a broadcasting station, may be embodied to include the configurations such as a tuner (not illustrated), a demodulator (not illustrated), an equalizer (not illustrated), and the like.

The signal processor 170 performs signal processing on the content received through the receiver 160. For example, the signal processor 170 may perform decoding, scaling, and frame rate conversion, etc., concerning videos composing the content, and do signal processing in a type which may be output from the display 120. In addition, the signal processor 170 may perform signal processing, such as decoding on an audio composing the content, and perform signal processing in the format which may be output from the audio output unit 190.

The remote controller signal receiver 180 receives a remote controller control signal input from a remote controller (not illustrated).

For example, the remote controller signal receiver 180 may receive a remote controller control signal to turn on the display apparatus 100 or display a menu.

Also, the remote controller signal receiver 180 may receive various remote controller control signals. For example, the remote controller signal receiver 180 may receive a remote controller control signal to change channels and control volume, and so on, and the controller 130 may change a channel of the display apparatus 100 or control volume according to the received remote controller control signal.

In addition, the remote controller signal receiver 180 may receive a remote controller control signal to execute a search program. The controller 130 may receive a remote controller signal to execute a search program and input a keyword, and perform a search. For example, when a remote controller signal is received to select a content search function, the controller 130 may execute a program to search the content, display a content search screen, and receive a keyword.

The audio output unit 190 may convert an audio signal output from the signal processor 170 into sound and output through a speaker (not illustrated), or through an external apparatus connected through an external output terminal (not illustrated).

To do this, the interface 195 may include at least one of HDMI (High-Definition Multimedia Interface) input terminal, component input terminal, PC input terminal, or USB input terminal, however, the present disclosure is not limited thereto.

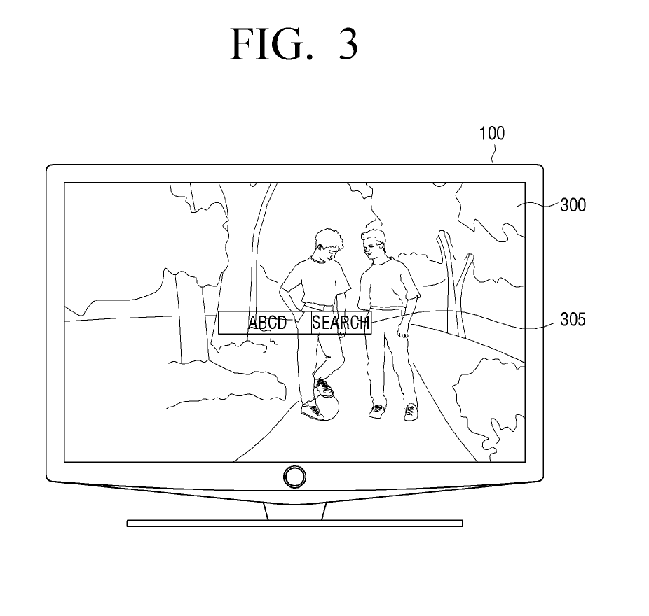

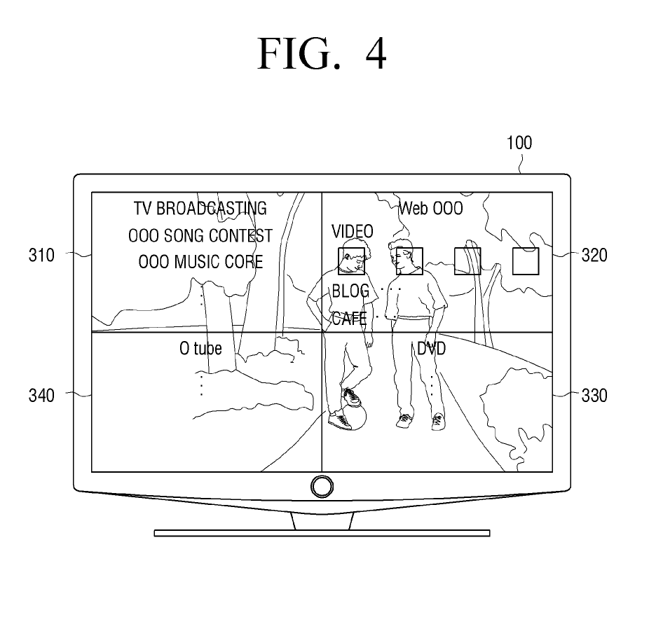

FIG. 3 and FIG. 4 are drawings to display a plurality of search result screens input according to an exemplary embodiment.

For example, like FIG. 3, when the original screen 300 is displayed on the display 120 and a search function is executed, a user interface (UI) 305 to receive a keyword may be displayed on or overlapping the original screen 300. In this case, when a keyword ABCD is input on a search window or UI 305, the controller 130 may perform search based on the inputted keyword ABCD.

Meanwhile, like FIG. 4, the controller 130 may generate a plurality of search result screens according to the searched ABCD from a plurality of sources and display the plurality of search result screens on the display 120. For example, a result screen 310 where ABCD is searched from a broadcasting channel, a result screen 320 where ABCD is searched from a web server, a result screen 330 where ABCD is searched from a content display apparatus connected to an external input port (e.g., DVD as shown in FIG. 4), and a result screen 340 where ABCD is searched from a portal site may be displayed on the display 120 as the split screens.

Particularly, the controller 130 may generate a plurality of search result windows as a screen having a first transparency and display the screen to be overlapped with the original screen 300. For example, transparency or transparencies of a result screen 310 where ABCD is searched from a broadcasting channel, a result screen 320 where ABCD is searched from a web server, a result screen 330 where ABCD is searched from a content display apparatus connected to an external input port, and a result screen 340 where ABCD is searched from a portal site may be adjusted and displayed to be overlapped with the original screen 300 displayed on the display 120. Accordingly, a user may check a plurality of search result screens 310, 320, 330, 340, while viewing the original screen 300 displayed on the display 120.

Meanwhile, when a content is selected from a first result screen among a plurality of search result screens, the controller 130 may generate the selected content screen as a screen having a second transparency and display the screen to be overlapped with the first search result screen.

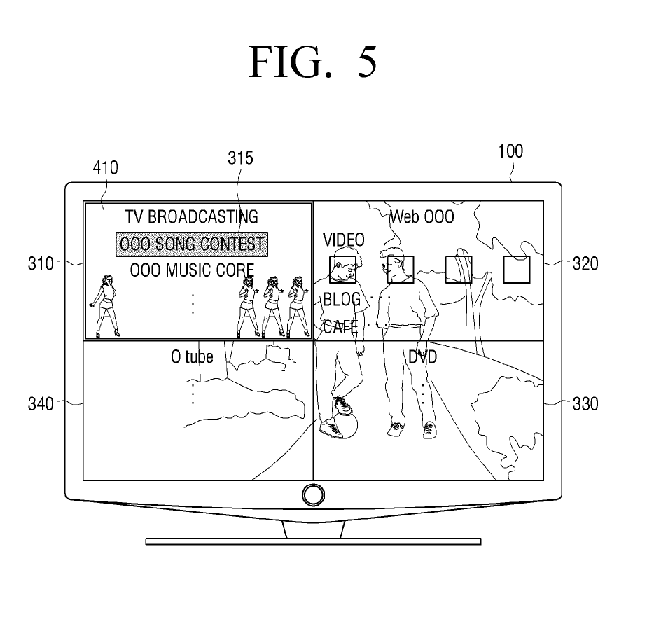

For example, referring to FIG. 5, when it is assumed that the first search result screen among the plurality of search result screens is a result screen 310 where ABCD is searched from a broadcasting channel, the controller 130, when ‘∘∘∘ Song Contest' is selected from the result screen 310 and ‘∘∘∘ Song Contest’ is highlighted 315, may adjust the transparency of the ‘∘∘∘ Song Contest’ screen 410 and display the screen to be overlapped with the result screen 310. Accordingly, a user may check ‘◯◯◯ Song Contest’ screen 410 while viewing the result screen 310 where ABCD is searched from the broadcasting channel displayed on the display 120.

For example, the controller 130 controls transparency of the result screen 310 where ABCD is searched from the broadcasting channel and ‘∘∘∘ Song Contest’ screen 410, so that the result screen 310 where ABCD is searched and ‘∘∘∘ Song Contest’ screen 410 are displayed only, and the original screen 300 corresponding to the screen 310 where ABCD is searched is not displayed.

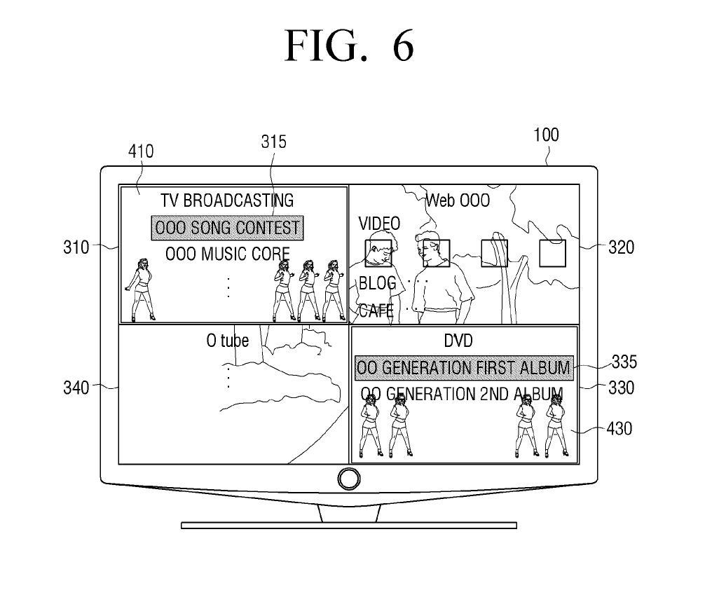

In addition, like FIG. 6, the controller 130, when a content is selected on two or more search result screens among a plurality of search result screens, may generate each selected content screen as a screen having a second transparency and display the screen to be overlapped with each search result screen.

For example, if it is assumed that two or more search result screens among a plurality of search result screens are a result screen 310 where ABCD is searched from a broadcasting channel and a result screen 330 where ABCD is searched from a content display apparatus connected to an external input port, the controller 130, when ‘∘∘∘ Song Contest’ is selected on the result screen 310 and when ‘∘∘ Generation First Album’ is selected on the result screen 330, highlights ‘∘∘∘ Song Contest’ and ‘∘∘ Generation First Album’ (elements 315 and 335 of FIG. 6). Further, the transparency of ‘∘∘∘ Song Contest’ screen 410 and ‘∘∘ Generation First Album’ screen 430 is adjusted, so that the screens are displayed to be overlapped with the result screen 310 and the result screen 330.

Meanwhile, the controller 130, when a content is re-selected on the first search result screen or a content screen is selected, may delete an original screen and a plurality of search result screens, and display the content screen in a full screen size.

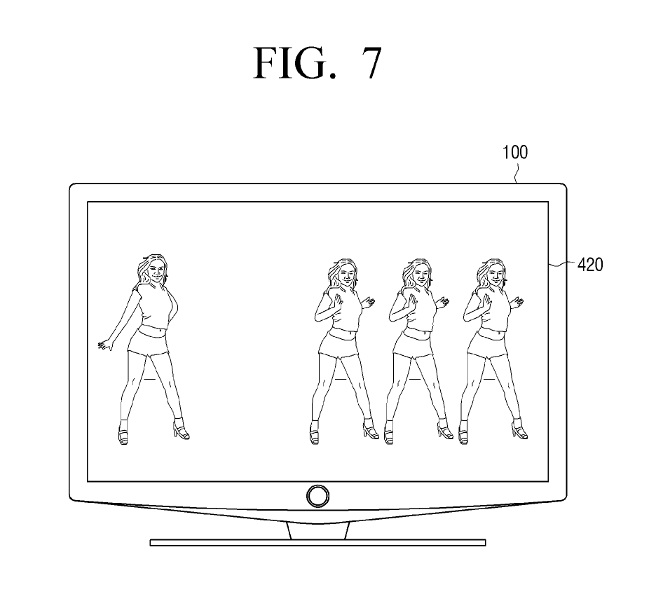

For example, referring to FIG. 7, when it is assumed that the first search result screen among the plurality of search result screens is a result screen 310 where ABCD is searched from a broadcasting channel, the controller 130, while ‘∘∘∘ Song Contest’ is selected on a result screen 310 where ABCD is searched from a broadcasting channel illustrated in FIGS. 6, and ‘∘∘∘ Song Contest’ screen 410 is displayed to be overlapped with the result screen where ABCD is searched from the broadcasting channel, when ‘∘∘∘ Song Contest’ is re-selected or ‘∘∘∘ Song Contest’ screen 410 is selected on the screen 310 where ABCD is searched from the broadcasting channel, may delete the original screen 300 and a plurality of search result screens 310, 320, 330, 340 and display ‘∘∘∘ Song Contest’ screen 410 on the full screen 420.

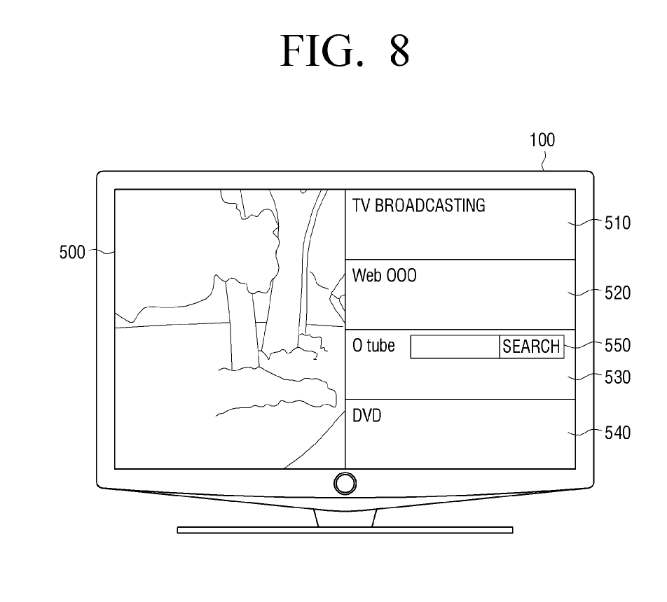

Meanwhile, FIG. 8 is a drawing which displays the original screen and a search screen on a split screen, according to an exemplary embodiment.

For example, the controller 130 may display the original screen 300 on one screen (500) among the split screens, and a plurality of source screens 510, 520, 530, and 540. The controller 130, while displaying the original screen 300 on one screen (500) among the split screens and the plurality of source screens 510, 520, 530, 540 on the remaining split screens, may display UI 550 to receive a keyword when search function is performed.

The controller 130, when a content is selected from a search result screen, may display a content screen on one screen (500) among the split screen where the original screen 300 is displayed.

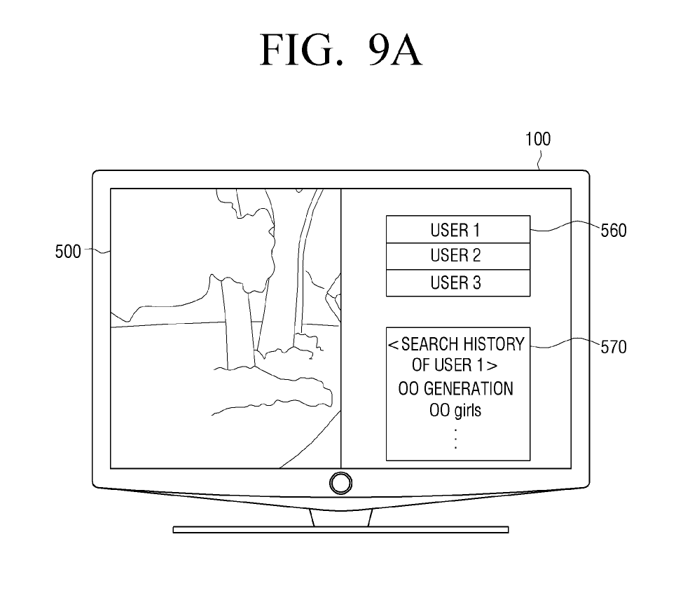

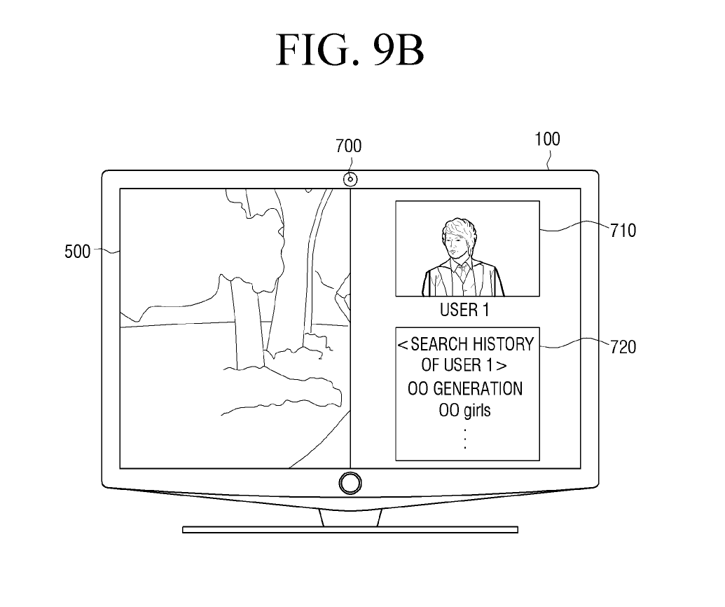

FIGS. 9A and 9B are drawings according to various exemplary embodiments to perform searches by user histories by users, identify a user through face recognition, for example, and display a screen to perform search by user histories by users.

In FIG. 9A, the controller 130 may display the UI 560 to detect a user on a split screen, and display the search result history 570 where keywords input during a predetermined period are listed, when a signal of a user 1 is input with a remote controller signal or a screen touch, etc.

For example, the controller 130 may perform the above-described search function, when a keyword among the search result history 570, where keywords input during a predetermined period are listed by a user 1, is re-input.

In FIG. 9B, the controller 130, when a user's face is recognized as a user 1 on a face recognition window 710 through a photographing unit 700, the search result history 720 which is listed keywords input during a predetermined period by the user 1 may be displayed.

In this case, in general, face recognition system may be divided into face detection step, face recognition step, and system realization step. The face area detection method which has been developed so far mainly includes a color-based face detection method using color substance of the HSI color model, a method using color information and movement information for face detection in a comprehensive manner, and a method of detecting face area by using color information and edge information of video, etc.

Also, face recognition method includes PCA (Principal Component Analysis), LDA, ICA, Tensorface, and so on.

Among the above, PCA is based on statistical features of vector, and is also called Karhunen-Loeve approximation method, which generates Eigen vector by the number of M of N dimension which has the statistical change by using covariance matrix of original data, reduces the space of N dimension to the space of M(N>M). Such analysis method is widely known as a practical method to reduce dimensions of different spaces and express them briefly.

Therefore, the controller 130, after detecting face through the photographing unit 700 and recognizing face at a face recognition window 710, may display search result history 720 of the corresponding user.

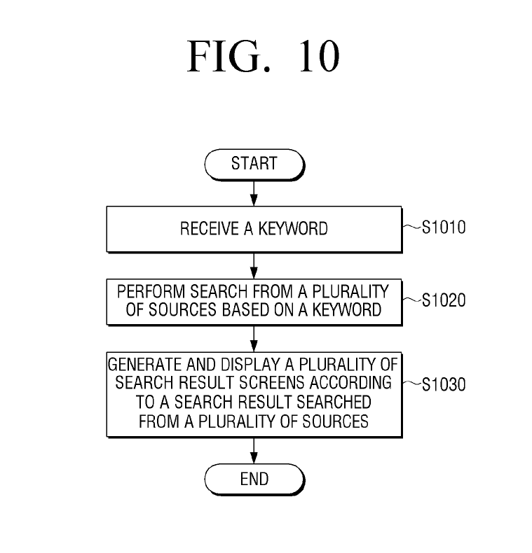

FIG. 10 is a flow chart to explain a method of displaying search result of a display apparatus, according to an exemplary embodiment.

The display apparatus 100 may receive a keyword to search a content (S1010).

In addition, the display apparatus 100, when a keyword is input, performs search from a plurality of sources based on the keyword (S1020). For example, the controller 130, when a keyword is input, may select a plurality of sources by using source information determined as a default. For example, a source which a user would like to search such as a broadcasting channel, a web server, USB, DVD player, a storage medium stored inside or outside a display apparatus, or other external apparatus may be selected. However, this is merely an example, and search may be performed from all the sources which may be communicated.

Afterwards, the display apparatus 100 generates and displays a plurality of search result screens according to search results searched from a plurality of sources (S1030). That is, when a plurality of sources are selected, search is performed from a plurality of sources based on keywords, and a plurality of search result screens may be generated according to search results searched from a plurality of sources.

To do this, the controller 130 splits screens and displays a plurality of search result screens on each split screen, and in this case, screens may be split according to the number of a plurality of sources.

A split screen may be embodied by using a PIP (Picture In Picture) screen. When using the PIP screen, it may be embodied that the size of the PIP screen is adjusted so that it may be seen as a split screen.

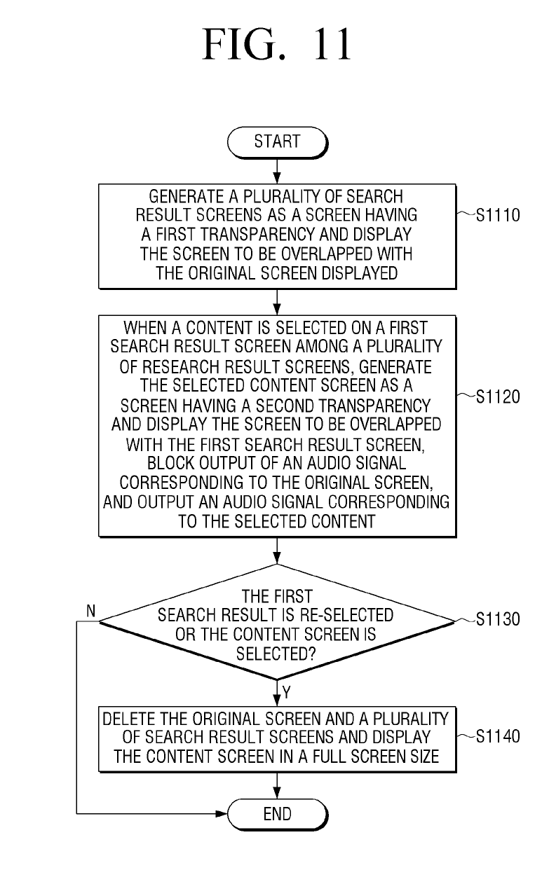

FIG. 11 is a flow chart which explains a method of displaying a plurality of search result screens of a display apparatus, according to an exemplary embodiment.

The display apparatus 100 generates a plurality of search result screens as a screen having a first transparency and displays the screen to be overlapped with the original screen displayed (S1110).

In addition, the display apparatus 100, when a content is selected on a first search result screen among a plurality of search result screens, generates the selected content screen as a screen having a second transparency and displays the screen to be overlapped with the first search result screen, blocks output of an audio signal corresponding to the original screen, and outputs an audio signal corresponding to the selected content (S1120).

Afterwards, the display apparatus 100 determines whether a first search result is re-selected or a content screen is selected (S1130).

As a result of determination, the display apparatus 100, when the first search result is not re-selected or the content screen is not selected (S1130-N), terminates the search.

Meanwhile, the display apparatus 100, when the first search result is re-selected or the content screen is selected (S1130-Y), deletes the original screen and a plurality of search result screens, and displays the content screen in a full screen size (S1140).

In addition, a non-transitory computer readable medium may be provided where a program which performs a method of displaying search result of the display apparatus sequentially is stored.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on non-transitory computer-readable media comprising computer-readable recording media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

Also, in the above-illustrated block diagram on the display apparatus, buses is not illustrated, but communication among each component of the display apparatus may be performed through buses. In addition, each device may further include processors such as CPU and micro processor which perform the above-described various steps.

Further, according to an aspect of the embodiments, any combinations of the described features, functions and/or operations can be provided.

Moreover, the apparatuses discussed above may include at least one processor to execute at least one of the above-described units and methods.

The foregoing embodiments and advantages are merely exemplary and are not to be construed as limiting the present invention. The present teaching may be readily applied to other types of devices.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A display apparatus, comprising:
an input unit configured to receive a keyword;
a display configured to display a screen based on search result received from a plurality of sources; and
a controller configured to control the plurality of sources to perform search based on the keyword, receive a plurality of search result screens corresponding to the search result searched from the plurality of sources, and display the screen including the search result screens on the display.

2. The apparatus of claim 1, wherein the controller, when the keyword is input, selects the plurality of sources by using source information set as a default.

3. The apparatus of claim 1, wherein the controller, when the keyword is input while a plurality of source screens are displayed on the display, controls a source corresponding to the plurality of source screens to search a content corresponding to the keyword.

4. The apparatus of claim 1, wherein the controller generates the plurality of search result screens as a screen having a first transparency, and displays the screen having the first transparency overlapped with an original screen displayed on the display.

5. The apparatus of claim 4, wherein, when a content is selected on a first search result screen which is one of the plurality of search result screens, the controller generates a selected content screen as a screen having a second transparency and displays the screen having the second transparency overlapped with the first search result screen.

6. The apparatus of claim 5, wherein, when the content is re-selected on the first search result screen, or the content screen is selected, the controller deletes the original screen and the plurality of search result screens, and displays the content screen in a full screen size.

7. The apparatus of claim 5, wherein, when a content is selected on a first search result screen which is one of the plurality of search result screens, the controller blocks output of an audio signal corresponding to the original screen and outputs an audio signal corresponding to the selected content.

8. The apparatus of claim 1, wherein the controller lists and displays a search result on the plurality of search result screens.

9. The apparatus of claim 1, wherein the plurality of sources comprise at least one of a broadcasting channel, a content display apparatus connected to an external input port, a storage media stored inside or outside the display apparatus, and a web server.

10. A method of displaying a search result of a display apparatus, the method comprising:
receiving a keyword to search a content;
controlling the plurality of sources to perform search based on the keyword; and
receiving a plurality of search result screens corresponding to a search result searched from the plurality of sources, and displaying a screen including the search result screens.

11. The method of claim 10, further comprising:
when the keyword is input, selecting the plurality of sources by using source information set as a default.

12. The method of claim 10, further comprising:
when the keyword is input while a plurality of source screens are displayed, controlling a source corresponding to the plurality of source screens to search a content corresponding to the keyword.

13. The method of claim 10, further comprising:
generating the plurality of search result screens as a screen having a first transparency and displaying the screen having the first transparency overlapped with an original screen displayed.

14. The method of claim 13, further comprising:
when a content is selected on a first search result screen which is one of the plurality of search result screens, generating a selected content screen as a screen having a second transparency, and
displaying the screen having the second transparency overlapped with the first search result screen.

15. The method of claim 14, further comprising:
when the content is re-selected on the first search result screen or the content screen is selected, deleting the original screen and the plurality of search result screens, and displaying the content screen in a full screen size.

16. The method of claim 14, further comprising:
when a content is selected on a first search result screen which is one of the plurality of search result screens, blocking output of an audio signal corresponding to the original screen, and
outputting an audio signal corresponding to the selected content.

17. The method of claim 10, wherein the displaying comprises listing and displaying a search result on the plurality of search result screens.

18. The method of claim 10, wherein the plurality of sources comprise at least one of a broadcasting channel, a content display apparatus connected to an external input port, a media stored inside or outside the display apparatus, and a web server.

19. An apparatus, comprising:
an input unit configured to receive a keyword;
a display configured to display a screen based on search result received from a plurality of sources; and
a controller configured to control the plurality of sources to perform search based on the keyword, and to display search result screens corresponding to the plurality of sources such that the search result screens overlap an original screen on the display.

20. The apparatus of claim 19, further comprising:
a photographing unit configured to recognize a user, wherein search result history of the recognized user during a predetermined period is displayed.
